(19) United States
(12) Patent Application Publication
(10) Pub. No.: US 2021/0153579 A1
(43) Pub. Date: May 27, 2021

(54) GLOVE COATING DEVICE

(71) Applicants: Gloveland Co., Ltd., Chilgok-gun (KR); Korea Research Institute for Fashion Industry, Daegu (KR)

(72) Inventor: Young Tae JI, Chilgok-gun (KR)

(21) Appl. No.: 16/993,413

(22) Filed: Aug. 14, 2020

(30) Foreign Application Priority Data
Nov. 26, 2019 (KR) 10-2019-0153658

(51) Int. Cl. A41D 19/04; A41D 19/00; B05C 3/08; B05D 1/18

(52) U.S. Cl. CPC A41D 19/04; A41D 19/0006; B29L 2031/4864; B05D 1/18; A41D 2500/54; B05C 3/08

(57) ABSTRACT

A glove coating device capable of supplying a coating layer in which pores are uniformly mixed is provided. The glove coating device includes: i) a dipping bath that is adapted to receive a coating liquid; ii) a coating liquid circulation tank installed in the dipping bath and that is spaced apart from a bottom surface of the dipping bath; iii) an impeller located in the dipping bath and that is adapted to transfer the coating liquid to the coating liquid circulation tank; iv) a motor positioned above the impeller to drive the impeller; and v) a drive shaft extending in the vertical direction to interconnect the motor and the impeller. The coating liquid circulation tank includes i) a first side opened to allow the coating liquid to be introduced; a second side formed on the opposite side of the first side and opened in a direction away from the bottom side to apply the coating liquid to overflow; and a flow passage communicating with the first side and the second side. The flow passage includes i) a first flow passage portion that is adapted to communicate with the first side and having a predetermined width that is smaller than the width of the coating liquid circulation tank, and ii) a second flow passage portion communicating with the first flow passage portion and the second side and gradually widening a width of the second flow passage portion from the first flow passage portion to the second side.

### CROSS-REFERENCE TO RELATED APPLICATION

This application claims priority to and the benefit of Korean Patent Applications Nos. 10-2019-0153658 filed in the Korean Intellectual Property Office on Nov. 26, 2019, the entire contents of which are incorporated herein by reference.

### STATEMENT REGARDING KOREAN GOVERNMENT SPONSORED RESEARCH OR DEVELOPMENT

This invention is supported by Ministry of the Interior and Safety, Korea, with Grant No. 2019-MOIS32-026 as disaster safety industry promotion program from Jun. 13, 2019 to Dec. 31, 2020 with a title of development of work safety glove with a reduced vibration of TRM(≤0.9)/TRH(≤0.6) and D level of cut resistant strength for preventing hand-arm vibration syndrome and amputation.

### BACKGROUND OF THE INVENTION

### (a) Field of the Invention

The present invention relates to a glove coating device. More specifically, it relates to a glove coating device capable of forming a coating layer having uniform porosity in the glove.

### (b) Description of the Related Art

Synthetic resins such as urethane or polyurethane are coated on the palm of work gloves made of general fabrics to prevent slipping and protect workers' hands. That is, after a dissolution tank in which a certain amount of a synthetic resin solid content such as polyurethane (PU) is dissolved in a solvent such as toluene, methylethylketone (MEK) dimethyl formamide (DMF), and so on is prepared, the glove weaved with cotton is dipped in the dissolution tank.

Ventilation holes exist in the inner skin of these work gloves. However, ventilation is not properly performed while the ventilation holes are blocked by the coating layer. Therefore, the conventional work gloves have a great decrease in breathability, thereby sweat easily stays on the hands, the wearing feeling is poor, and the use thereof is uncomfortable.

### SUMMARY OF THE INVENTION

A glove coating device capable of forming a coating layer having uniform porosity in gloves is provided in order to have breathability.

A glove coating device according to an embodiment of the present invention includes a glove coating device including: i) a dipping bath that is adapted to receive a coating liquid; ii) a coating liquid circulation tank installed in the dipping bath and spaced apart from a bottom surface of the dipping bath; iii) an impeller located in the dipping bath and that is adapted to transfer the coating liquid to the coating liquid circulation tank; iv) a motor positioned above the impeller to drive the impeller; and v) a drive shaft extending in the vertical direction to interconnect the motor and the impeller. The coating liquid circulation tank includes: i) a first side opened to allow the coating liquid to be introduced; a second side formed on the opposite side of the first side and opened in a direction away from the bottom side to apply the coating liquid to overflow; and a flow passage communicating with the first side and the second side. The flow passage includes i) a first flow passage portion that is adapted to communicate with the first side and having a predetermined width that is smaller than the width of the coating liquid circulation tank, and ii) a second flow passage portion communicating with the first flow passage portion and the second side and gradually widening a width of the second flow passage portion from the first flow passage portion to the second side.

The impeller may include i) a first rotating body, and ii) a second rotating body located on the first rotating body. The first rotating body may include i) a first circular head portion, and ii) a plurality of first linear wing portions connected to the first circular head portion along a circumference of the first circular head portion and extending in a radial direction to be spaced apart from each other. The second rotating body may include i) a second circular head portion located above the first circular head portion, and ii) a plurality of second linear wing portions connected to the first circular head portion along a circumference of the first circular head portion, extending in a radial direction, and spaced apart from each other, and alternately positioned with the plurality of first linear wing portions.

At least one second linear wing portion of the plurality of second linear wing portions may be formed by being inclined downward, and an angle formed between the second linear wing portion and a horizontal direction may be greater than 0° and less than or equal to 20°. An angle between the first linear wing portion of the plurality of first linear wing portions and the second linear wing portion next to the first linear wing portion may be in a range of 20° to 30°. The first head portion may be formed with a plurality of first air inlets formed radially and symmetrically with respect to the drive shaft. The second head portion may be formed with a plurality of second air inlets corresponding to the plurality of first air inlets.

The first air inlets and the second air inlets may be disposed in an equilateral triangle shape around the drive shaft. The first air inlets and the second air inlets may be formed to have a circular shape, respectively.

The driveshaft may be positioned through the first side and the coating liquid may be adapted to be introduced into the first side as the impeller rotates. The driveshaft may be located near the inlet of the first flow passage.

The width of the first flow passage portion may be smaller than the width of the coating liquid circulation tank, and the width of the first flow passage portion may be in a range from 50 mm to 60 mm. The width of one end of the second flow passage portion may be the same as the width of the first flow passage portion, and the width of the other end of the second flow passage portion may be the same as the width of the second side.

A glove coating device according to an embodiment of the present invention includes supports connected to the inner surface of the dipping bath and the coating liquid circulation tank. The coating liquid circulation tank may be supported by the supports which are elongated along a longitudinal direction of the coating liquid circulation tank. The coating liquid circulation tank may be located between the supports. The supports may be formed into a rod shape.

The at least one space may be formed along a direction crossing the longitudinal direction between the dipping bath and the coating liquid circulation tank. The glove may be adapted to be dipped in the coating liquid to be coated in the space. The at least one space may have two spaces, and the coating liquid circulation tank may be located between the two spaces.

It is thereby possible to provide a glove formed with a coating layer having uniform porosity. That is, when air bubbles are contained in the coating liquid of the glove coating device, in the process of coating and drying the glove, the air bubbles are blown and pores are formed in the glove, thereby allowing the glove to pass through, thereby imparting breathability to the gloves. Therefore, even when the gloves are used for work, sweat is not maintained in the gloves, it is possible to improve the fit when working when using gloves, and they can be used for a long time.

### BRIEF DESCRIPTION OF THE DRAWINGS

FIG. 1 is a schematic perspective view of a glove coating device according to an embodiment of the present invention.

FIG. 2 is a schematic perspective view of an impeller included in the glove coating device of FIG. 1.

FIGS. 3A to 3C are schematic views sequentially showing step-by-step operating states during the glove coating process of the impeller of FIG. 2.

FIG. 4 is a schematic operating state diagram of the glove coating device of FIG. 1.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention. Advantages and characteristics of the technical disclosure and methods for achieving them should become apparent with reference to exemplary embodiments described in detail below in addition to the accompanying drawings. However, the scope of the disclosure is not limited to the exemplary embodiments which will be described below, and may be implemented in various forms. Throughout the specification, like elements refer to like reference numerals. Detailed description of the well-known prior art is omitted.

It will be understood that, although the terms first, second, etc., may be used herein to describe various elements, these elements should not be limited by these terms. These terms are only used to distinguish one element from another. As used herein, the singular forms “a”, “an”, and “the” are intended to include the plural forms as well, unless the context clearly indicates otherwise. In addition, when a unit “comprises” an element, the unit does not exclude another element but may further include another element unless the context clearly indicates otherwise.

Hereinafter, embodiments of the present invention will be described in detail with reference to the accompanying drawings so that those skilled in the art can easily carry out the present invention. The present invention may, however, be embodied in many different forms and should not be construed as limited to the embodiments set forth herein.

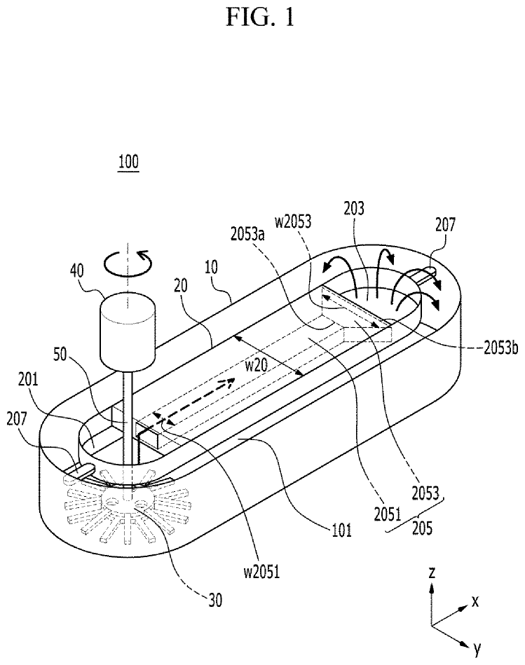

FIG. 1 schematically shows a glove coating device 100 according to an embodiment of the present invention. The structure of the glove coating device 100 of FIG. 1 is only for illustrating the present invention, and the present invention is not limited thereto. Therefore, the glove coating device can be modified into other forms.

The glove coating device 100 includes a dipping bath 10, a coating liquid circulation tank 20, an impeller 30, a motor 40, and a driveshaft 50. In addition, the glove coating device 100 may further include other parts. Although not shown in FIG. 1 for convenience, the glove coating device 100 may further include a holder. The holder holds a plurality of gloves to dip the dipping bath 10. In addition, although not shown in FIG. 1, the coating liquid inlet may be connected to the dipping bath 10 so that the coating liquid may be supplied to the dipping bath 10 through the coating liquid inlet. The coating liquid inlet may be located on a left side of the coating liquid circulation tank 20.

As shown in FIG. 1, the dipping bath 10 accommodates a coating liquid. For example, the dipping bath 10 may use a coating liquid having viscosity of 1200 cps. The coating liquid contains components with a large specific gravity such as pigments, fillers, and additives. Therefore, it is necessary to circulate the coating liquid so that these components do not sink.

The coating liquid circulation tank 20 is installed in the dipping bath 10. The coating liquid circulation tank 20 is spaced apart from a bottom surface 101 of the dipping bath 10 and is located above the coating liquid circulation tank 20. That is, since the coating liquid circulation tank 20 is located to be spaced apart from the bottom surface 101 in the +z axis direction, the coating liquid is accommodated and flows therebetween. Air bubbles are supplied to the coating liquid, but the air bubbles disappear or coalesce over time, and their size becomes larger. Therefore, to prevent this, the coating liquid is continuously circulated by using the impeller 30, and the air bubbles are uniformly dispersed and broken apart.

As illustrated in FIG. 1, the coating liquid circulation tank 20 includes a first side 201, a second side 203, and a flow passage 205. The coating liquid circulation tank 20 is supported by supports 207 connected to the inner surface of the dipping bath 10 along the x-axis direction, respectively. The supports 207 are elongated and formed into a rod shape. When the supports 207 are installed in the y-axis direction, interference with gloves dipping into the dipping bath 10 may occur. Therefore, it is preferable to install the supports 207 in the x-axis direction. Meanwhile, the coating liquid circulation tank 20 may further include other parts.

The first side 201 is opened so that the coating liquid is introduced therein. That is, the coating liquid flows into the first side 201 along the +z axis direction. As the impeller 30 rotates, the level of the coating liquid may be greatly increased. In this case, the coating liquid is introduced into the first side 201 to flow along the coating liquid circulation tank 20. The coating liquid flowing into the first side 201 flows along the flow passage 205 in the +x axis direction.

The flow passage 205 includes a first flow passage portion 2051 and a second flow passage portion 2053. The first flow passage portion 2051 communicates with the first side 201. That is, the first flow passage portion 2051 is located next to the first side 201 and is connected to the first side 201. Here, the width w2051 of the first flow passage portion 2051 is smaller than the width w20 of the coating liquid circulation tank 20. That is, both sides of the coating liquid circulation tank 20 are closed but are opened therebetween to form the first flow passage portion 2051 having a constant width w2051. As a result, the coating liquid maintaining the state of containing the air bubbles in a relatively small amount flows into the coating liquid circulation tank 20 along the first flow passage portion 2051. The coating liquid flows into the coating liquid circulation tank 20 only when the level of the coating liquid increases as the rotational speed of the impeller 30 increases. Therefore, the amount of coating liquid that does not flow into the coating liquid circulation tank 20 and stays intact is not very large. Therefore, the cross-sectional area of the first flow passage portion 2051 is formed in this point. The width w2051 of the first flow passage portion 2051 may be, for example, 50 mm to 60 mm. When the width w2051 is too small, the amount of coating liquid circulated along the coating liquid circulating tank 20 is too small, and thus the circulation of the coating liquid in the dipping bath 10 is not well achieved. Conversely, when the width w2051 is too large, the flow rate required for circulation of the coating liquid cannot be secured. Therefore, it is preferable to transfer the coating liquid in the direction of the dotted arrow with the width w2051 in the above-described range.

The second flow passage portion 2053 communicates with the first flow passage portion 2051 and the second side 203. The second flow passage portion 2053 has a structure in which the width w2053 gradually widens from the first flow passage portion 2051 to the second side 203. That is, a left end portion 2053a of the second flow passage portion 2053 has the same width as the width w2051 of the first flow passage portion 2051, and aright end portion 2053b of the second flow passage portion 2053 has the same width as the width of the second side 203. The width w2053 of the second flow passage portion 2053 gradually increases toward the +x axis direction therebetween. Therefore, the coating liquid flowing along the +x-axis direction through the first flow passage portion 2051 is prepared in a state suitable for overflow from the second side 203 without a bottleneck. As a result, circulation of the coating liquid can be smoothly performed.

The second side 203 is formed on the opposite side of the first side 201. That is, the second side 203 is spaced apart from the first side 201 along the x-axis direction and is located on the opposite side. The second side 203 has a bottom, but is formed to make its upper part open, that is, be open in a direction away from the bottom surface 101 in the +z axis direction. In the flow passage 205, the coating liquid is transferred at a relatively high speed in a closed state, then meets the second side 203, and overflows in multiple directions as indicated by the arrows. The coating liquid having broken apart air bubbles is recycled and flows to the dipping bath 10. As described above, the second side 203 must be formed wide to recycle the coating fluid through the second side 203 without a bottleneck. Therefore, the second side 203 has a relatively large area and is formed to be open in the +z axis direction.

The motor 40 is located above the impeller 30 to drive the impeller 30 in the direction of the arrow. The motor 40 may be driven by electricity or hydraulic pressure. The motor 40 is connected to the impeller 30 through the drive shaft 50.

As shown in FIG. 1, the drive shaft 50 extends in the vertical direction, that is, in the z-axis direction, to interconnect the impeller 30 and the motor 40. In FIG. 1, the driveshaft 50 is illustrated as being positioned through the first side 201 of the coating liquid circulation tank 20, but otherwise, it is sufficient if it is located only near the inlet of the first flow passage 2051.

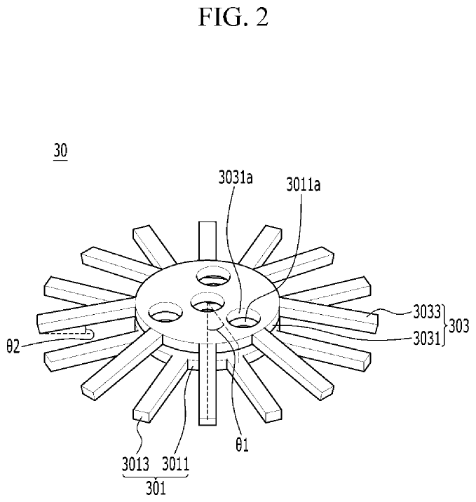

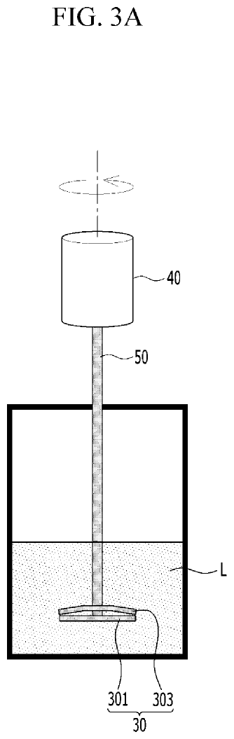

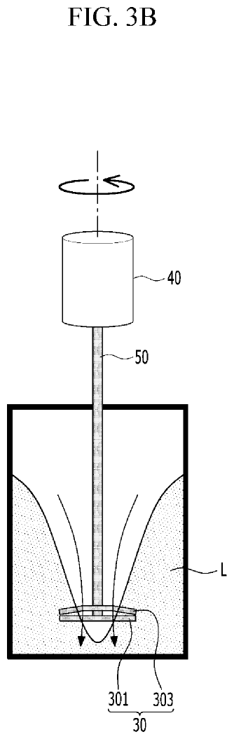

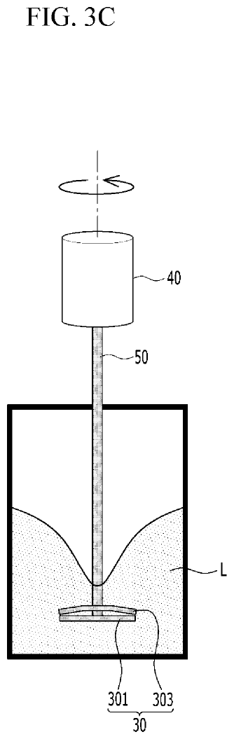

The impeller 30 is located in the dipping bath 10 to stir the coating liquid. As the impeller 30 rotates, air is naturally injected into the coating liquid and then the coating liquid contains a plurality of bubbles which are broken apart into small bubbles. The impeller 30 is located on a left side of the coating liquid circulation tank 20. The impeller 30 transfers the coating liquid to the coating liquid circulation tank 20 by rotation. Therefore, the impeller 30 plays a dual role of transferring the coating liquid to the coating liquid circulation tank 20 while stirring the coating liquid accommodated in the dipping bath 10. Furthermore, the impeller 30 may provide a coating layer in which vent holes are appropriately formed in a glove by injecting air into the coating liquid and breaking it apart to form a plurality of bubbles. Hereinafter, the structure of the impeller 30 in charge of that role will be described in more detail with reference to FIGS. 2 and 3.

FIG. 2 schematically shows the impeller 30 of FIG. 1. The structure of the impeller 30 in FIG. 2 is only for illustrating the present invention and the present invention is not limited thereto. Therefore, the impeller can be modified to other forms.

As shown in FIG. 2, the impeller 30 includes a first rotating body 301 and a second rotating body 303. In addition, the impeller 30 may further include other parts as necessary. The first rotating body 301 includes a first circular head portion 3011 and a first linear wing portion 3013, and the second rotating body 303 includes a second circular head portion 3031 and a second linear wing Includes part 3033.

The first rotating body 301 and the second rotating body 303 have similar shapes, but their roles are different from each other. That is, the first rotating body 301 smoothly stirs the coating liquid by rotation, while the second rotating body 303 presses the coating liquid by high-speed rotation of the impeller 30 while stirring the coating liquid, thereby air is introduced into the coating liquid from the upper portion thereof. For smooth injection of air, air inlets 3011a and 3031a are formed in the first circular head portion 3011 and the second circular head portion 3031, respectively. Accordingly, when the first rotating body 301 presses the coating liquid by rotation, an air layer is formed thereon, contacting the coating liquid, and the air is introduced into the coating liquid through the air inlets 3011a and 3031a. As a result, a number of bubbles can be formed in the coating liquid. The second circular head portion 3031 is formed thereon corresponding to the first circular head portion 3011, and the air inlets 3011a and 3031a are also communicated with each other. As a result, air can be smoothly injected into the coating liquid.

The first air inlets 3011a are formed symmetrically based on the drive shaft 50. In addition, the second air inlets 3031a are also formed symmetrically with respect to the drive shaft 50. That is, the first air inlets 3011a and the second air inlets 3031a are disposed in an equilateral triangle shape around the drive shaft 50, respectively. Since the first air inlets 3011a and the second air inlets 3031a are formed to have a circular shape, respectively, the impact on the first circular head portion 3011 and the second circular head portion 3031 caused by air inflow is minimized. Meanwhile, the first air inlets 3011a and the second air inlets 3031a are radially opened symmetrically with respect to the drive shaft 50. As a result, the same amount of air bubbles can be uniformly formed in the coating liquid regardless of the position. Therefore, it is possible to inject a uniform amount of air around the drive shaft 50 within a range that does not impart a large force to the rotation of the impeller 30.

The first linear wing portions 3013 are connected to the first circular head portion 3011 along the circumference of the first circular head portion 3011. That is, the first linear wing portions 3013 are attached to the edge of the first circular head portion 3011. The first linear wing portions 3013 are spaced apart from each other for efficient stirring of the coating liquid. Meanwhile, the second linear wing portions 3033 are also connected to the second circular head portion 3031 along the circumference of the second circular head portion 3031. The second linear wing portions 3033 are attached to the edge of the second circular head portion 3031. The second linear wing portions 3033 are also spaced apart from each other. The second linear wing portions 3033 are alternately positioned with the first linear wing portions 3013. That is, the first linear wing portions 3013 are positioned between the second linear wing portions 3033. The angle θ1 formed between the first linear wing portions 3013 and the second linear wing portions 3033 next to each other may be 20° to 30°. If the angle θ1 is too small, the distance between the adjacent first linear wing portions 3013 and second linear wing portions 3033 is too small. Therefore, when the impeller 30 rotates at a high speed, the first linear wing portions 3013 and the second linear wing portions 3033 may be damaged by mutual contact. Conversely, when the angle θ1 is too large, the number of the first linear wing portions 3013 and the number of second linear wing portions 3033 are too small, it is difficult to stir the coating liquid efficiently. Therefore, the angle θ1 is maintained in the above-described range. For example, when the number of the first linear wing portions 3013 and the number of the second linear wing portions 3033 are seven, respectively, each angle θ1 may be 25.7 degrees.

In order to smoothly introduce air into the coating liquid, the second linear wing portions 3033 are formed to incline downward. That is, the angle θ2 formed by the second linear wing portions 3033 with the horizontal direction may be greater than 0° and equal to or less than 20°. If the angle θ2 is 0°, since the second linear wing portions 3033 are formed in a horizontal direction, it may be difficult to inject air into the coating liquid. In addition, if the angle θ2 is too large, when the impeller 30 rotates, it is highly likely that a vortex would be generated which prevents agitation by the first linear blade parts 3013. Therefore, it is desirable to keep the angle θ2 within the above-described range. Hereinafter, a step-by-step operation state of the above-described impeller 30 will be described in more detail through FIGS. 3A to 3C.

FIGS. 3A to 3C show the stepwise operating states in order during the glove coating process of the impeller 30 of FIG. 2. More specifically, FIG. 3A represents a state in which the impeller 30 mixes the coating liquid, FIG. 3B represents a state in which air is injected into the coating liquid by the impeller 30, and FIG. 3C shows the state of breaking up air bubbles by the impeller 30. The operating state of the impeller 30 of FIGS. 3A to 3C is merely for illustrating the present invention, and the present invention is not limited thereto. Therefore, the operating state of the impeller 30 can be modified to other forms.

First, in FIG. 3A, the coating liquid is mixed. As shown in FIG. 3A, the coating liquid can be uniformly mixed using the impeller 30. For example, the coating liquid is uniformly mixed by rotating the impeller 30 at a speed of 800 rpm. In this case, since the rotational speed of the impeller 30 is not high, the coating liquid maintains a calm horizontal level.

Next, in FIG. 3B, air is injected into the coating liquid. When a plurality of bubbles are formed in the coating liquid, a number of pores are formed in the coating layer. Thus, air permeability of the coated glove is improved. For this, for example, the rotational speed of the impeller 30 may be increased up to 2000 rpm, and in this case, the viscosity of the coating liquid may increase up to 1500 cps. A high level difference is formed in the coating liquid around the impeller 30. As a result, air may be introduced through the air inlets 3011a and 3031a as indicated by the arrows. That is, on a central side of the impeller 30, the level of the coating liquid is the lowest by the rotational force of the impeller 30, and the level rises as it moves away from the impeller 30 and goes to its periphery. In this case, the amount of air injected into the coating liquid may be 20 vol % to 25 vol % of the total coating liquid. When the amount of air is small, a sufficient amount of pores cannot be formed in the coating layer coated on the glove in a subsequent process. In addition, when the amount of air is too large, the viscosity of the coating liquid increases, and too many bubbles are formed therein, so that it is difficult for the coating to be smoothly performed. Therefore, it is desirable to keep the amount of air contained in the coating liquid in the above-described range.

Finally, in FIG. 3C, the air bubbles are mechanically broken apart. For example, when the rotational speed of the impeller 30 is lowered to 1600 rpm, the air injected into the coating liquid is trapped in the coating liquid again as the level lowers, and the air bubbles are broken apart by the collision of the first linear wing portions 3013 and the second linear wing portions 3033. Therefore, a number of broken apart small bubbles are uniformly mixed in the coating liquid. If the bubbles are formed to be large, large pores may be formed in the coating layer formed on the glove later, resulting in poor coating of the glove. This phenomenon can be prevented by breaking the bubbles apart. Since the coating liquid formed by the above-described method is supplied to the coating liquid circulation tank 20, it is possible to uniformly disperse and mix bubbles in the coating liquid accommodated in the dipping bath 10.

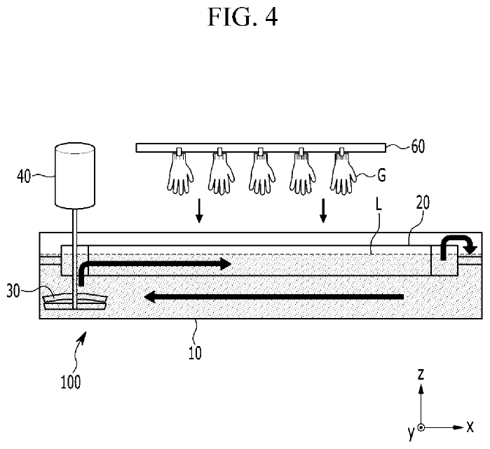

FIG. 4 schematically shows an operating state of the glove coating device 100 of FIG. 1. More specifically, FIG. 4 schematically shows a state in which the glove is coated by dipping it in the glove coating device 100, and shows the state in which the glove coating device 100 of FIG. 1 is viewed in the +y axis direction. The operating state of the glove coating device 100 is only for illustrating the present invention, and the present invention is not limited thereto. Therefore, the operating state of the glove coating device 100 can be modified to other forms.

As shown in FIG. 4, the coating liquid is supplied to the coating liquid circulation tank 20 as the impeller 30 rotates and then flows in the horizontal direction, that is, in the +x axis direction. The coating liquid flowing to the right end of the coating liquid circulation tank 20 overflows and is circulated back to the dipping bath 10. The coating liquid accommodated in the dipping bath 10 is uniformly mixed according to this mechanism.

The plurality of gloves G made of fabric or the like are transported through a holder 60 and moved in the direction of the arrow, that is, in the direction of the −z axis, and are coated by dipping them in the dipping bath 10. By using the holder 60, it is possible to increase the coating efficiency by dipping the plurality of gloves G into the dipping bath 10 at a time.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A glove coating device comprising:
a dipping bath that is adapted to receive a coating liquid;
a coating liquid circulation tank installed in the dipping bath and spaced apart from a bottom surface of the dipping bath;
an impeller located in the dipping bath and that is adapted to transfer the coating liquid to the coating liquid circulation tank;
a motor positioned above the impeller to drive the impeller; and
a drive shaft extending in the vertical direction to interconnect the motor and the impeller, and wherein
the coating liquid circulation tank comprises:
a first side opened to allow the coating liquid to be introduced;
a second side formed on the opposite side of the first side and opened in a direction away from the bottom side to apply the coating liquid to overflow; and
a flow passage communicating with the first side and the second side, and wherein
the flow passage comprises:
a first flow passage portion that is adapted to communicate with the first side and having a predetermined width that is smaller than the width of the coating liquid circulation tank; and
a second flow passage portion communicating with the first flow passage portion and the second side and gradually widening a width of the second flow passage portion from the first flow passage portion to the second side.

2. The device of claim 1, wherein the impeller comprises:
a first rotating body; and
a second rotating body located on the first rotating body, and wherein
the first rotating body comprises:
a first circular head portion; and
a plurality of first linear wing portions connected to the first circular head portion along a circumference of the first circular head portion and extending in a radial direction to be spaced apart from each other, and wherein
the second rotating body comprises:
a second circular head portion located above the first circular head portion; and
a plurality of second linear wing portions connected to the first circular head portion along a circumference of the first circular head portion, extending in a radial direction, and spaced apart from each other, and alternately positioned with the plurality of first linear wing portions.

3. The device of claim 2, wherein at least one second linear wing portion of the plurality of second linear wing portions is formed by being inclined downward, and an angle formed between the second linear wing portion and a horizontal direction is greater than 0° and less than or equal to 20°.

4. The device of claim 3, wherein an angle between the first linear wing portion of the plurality of first linear wing portions and the second linear wing portion next to the first linear wing portion is in a range of 20° to 30°.

5. The device of claim 3, wherein the first head portion is formed with a plurality of first air inlets formed radially and symmetrically with respect to the drive shaft, and
the second head portion is formed with a plurality of second air inlets corresponding to the plurality of first air inlets.

6. The device of claim 5, wherein the first air inlets and the second air inlets are disposed in an equilateral triangle shape around the drive shaft.

7. The device of claim 5, wherein the first air inlets and the second air inlets are formed to have a circular shape, respectively.

8. The device of claim 1, wherein the driveshaft is positioned through the first side and the coating liquid is adapted to be introduced into the first side as the impeller rotates.

9. The device of claim 1, wherein the driveshaft is located near the inlet of the first flow passage.

10. The device of claim 1, wherein the width of the first flow passage portion is smaller than the width of the coating liquid circulation tank and the width of the first flow passage portion is in a range from 50 mm to 60 mm.

11. The device of claim 1, wherein the width of one end of the second flow passage portion is the same as the width of the first flow passage portion and the width of the other end of the second flow passage portion is the same as the width of the second side.

12. The device of claim 1, further comprising supports connected to the inner surface of the dipping bath and the coating liquid circulation tank, and wherein the coating liquid circulation tank is supported by the supports which are elongated along a longitudinal direction of the coating liquid circulation tank.

13. The device of claim 12, wherein the coating liquid circulation tank are located between the supports.

14. The device of claim 12, wherein the supports are formed into a rod shape.

15. The device of claim 12, wherein the at least one space is formed along a direction crossing the longitudinal direction between the dipping bath and the coating liquid circulation tank, and the glove is adapted to be dipped in the coating liquid to be coated in the space.

16. The device of claim 15, wherein the at least one space has two spaces and the coating liquid circulation tank is located between the two spaces.
